(19) United States
(12) Patent Application Publication
(10) Pub. No.: US 2015/0127164 A1
(43) Pub. Date: May 7, 2015

(54) PERFORMANCE MANAGEMENT SYSTEM, METHOD AND NON-TRANSITORY COMPUTER READABLE STORAGE MEDIUM THEREOF

(71) Applicant: INSTITUTE FOR INFORMATION INDUSTRY, Taipei (TW)

(72) Inventors: Ko-Yang WANG, Taipei City (TW); Grace LIN, Hualien County (TW); Hui-I HSIAO, Yunlin County (TW); Roger-R. GUNG, Taipei City (TW); Shu-Ping LIN, Hsinchu City (TW); Chien LIN, New Taipei City (TW); Jui Wen CHANG, Taipei City (TW); Jiun-Hau YE, New Taipei City (TW); Ming-Lung WENG, Changhua County (TW); Wei-Wen WU, New Taipei City (TW); Yi-Hsin WU, Taipei City (TW); Cheng-Juei YU, Taipei City (TW)

(73) Assignee: INSTITUTE FOR INFORMATION INDUSTRY, Taipei (TW)

(21) Appl. No.: 14/086,998

(22) Filed: Nov. 22, 2013

(30) Foreign Application Priority Data
Nov. 7, 2013 (TW) 102140506

(51) Int. Cl. G05B 15/02

(52) U.S. Cl. CPC G05B 15/02
USPC 700/275

(57) ABSTRACT

A performance management system, method and a non-transitory computer readable storage medium are disclosed herein. The performance management system includes a value-driven management module and an integrated control module. The value-driven management module includes a value-driven model configuration unit and a value-driven target configuration unit. The value-driven model configuration unit is configured to configure a value-driven model with a plurality of targets, and the targets respond to a plurality of factors. The value-driven target configuration unit is configured to set a goal value for each of the targets. The integrated control module is configured to monitor a performance of a building in accordance with the goal value for each of the targets and the value-driven model.

### RELATED APPLICATIONS

This application claims priority to Taiwan Application Serial Number 102140506, filed Nov. 7, 2013, which is herein incorporated by reference.

### BACKGROUND

1. Field of Invention

The present invention relates to a performance management system. More particularly, the present invention relates to a performance management system that is value-driven and suitable for smart building.

2. Description of Related Art

So far as a building management is concerned, it is used to monitor and maintain ventilation and lighting system at certain level, so as to improve comfort level of the indoor environment. Thus, maintenance costs (for instance, utility fee) increase accordingly.

Furthermore, comfort level of the indoor environment and maintenance costs are influenced by many factors. Building owners should take these factors into account to make a trade-off between the comfort level and maintenance costs. However, while the comfort level and the maintenance costs are influenced by too many factors, building owners usually cannot make adequate decisions on building operation and predict the building performance accurately.

Therefore, a heretofore unaddressed need exists to address the aforementioned deficiencies and inadequacies.

### SUMMARY

One aspect of the present invention is to provide a performance management system. The performance management system includes a value-driven management module and an integrated control module. The value-driven management module includes a value-driven model configuration unit and a value-driven target configuration unit. The value-driven model configuration unit is configured to configure a value-driven model with a plurality of targets, and the targets respond to a plurality of factors. The value-driven target configuration unit is configured to set a goal value for each of the targets. The integrated control module is configured to monitor the performance of at least one building in accordance with the goal value for each of the targets and the value-driven model.

According to one embodiment of the present invention, the performance management system further includes an analytical module. The analytical module is configured to obtain the items corresponding to the factors in accordance with operation data of at least one electromechanical system of the at least one building and at least one environment data of the at least one building. The analytical module configures the value-driven model in accordance with the items corresponding to the factors, and the items corresponding to the factors are related to the at least one electromechanical equipment.

According to one embodiment of the present invention, the analytical module generates the prediction of operation data in accordance with the operation data, the environment data and the items corresponding to the factors.

According to one embodiment of the present invention, the analytical module generates a prediction of factor data in accordance with the operation data, environment data and the items corresponding to the factors. The analytical module configures the items corresponding to the factors in accordance with the goal value for each target and the prediction data, so as to generate a prediction of performance values for the targets.

According to one embodiment of the present invention, the analytical module generates the prediction of operation data in accordance with the prediction of performance values and the factors. The analytical module further generates an electromechanical equipment control value in accordance with the prediction of factor data and the prediction of operation data, and the integrated control module controls the at least one electromechanical equipment in accordance with the electromechanical equipment control value.

According to one embodiment of the present invention, the performance management system further includes a rule management module. The rule management module is configured to establish monitoring rules in accordance with the electromechanical equipment control value. The rule management module is configured to monitor the at least one electromechanical and electrical equipment based on the operation data, the prediction of operation data and the at least one monitoring rule.

According to one embodiment of the present invention, the performance management system further includes a building subsystem integration module. The building subsystem integration module is configured to periodically record the operation data and the environment data. The analytical module obtains the record operation data and environment data from the building subsystem integration module.

Another aspect of the present invention is to provide a performance management method that is configured to manage at least one smart building. The smart building includes at least one electromechanical equipment. The performance management method includes the following steps: configuring a value-driven model that includes a plurality of targets responding to a plurality of factors; setting a goal value for each of the targets; monitoring the at least one electromechanical equipment based on the value-driven model and the goal value for each of the targets.

According to one embodiment of the present invention, the performance management method further includes the steps: obtaining a plurality of items corresponding to the factors based on an operation data of the at least one electromechanical equipment and an environment data of the smart building, and the items corresponding to the factors related to the at least one electromechanical equipment, so as to configure the value-driven model; and generating a prediction of the factor data and a prediction of the operation data based on the operation data, the environment data and the items corresponding to the factors.

According to one embodiment of the present invention, the step of generating a prediction of factor data and a prediction of operation data includes: configuring the items corresponding to the factors based on the goal value for each of the targets and the prediction of factor data, so as to generate a prediction of performance values for the targets; and generating a prediction of operation data based on the prediction performance values and configured items corresponding to the factors.

According to one embodiment of the present invention, the step of monitoring the at least one electromechanical equipment includes: generating an electromechanical equipment control value based on the prediction of factor data and the prediction of operation data to monitor the at least one electromechanical equipment.

According to one embodiment of the present invention, the performance management method further includes the steps: establishing at least one monitoring rule in accordance with the electromechanical control value; monitoring the at least one electromechanical equipment based on the operation data, the prediction of the operation data, and the at least one monitoring rule.

According to one embodiment of the present invention, the performance management method further includes the steps: periodically recording the operation data and environment data of the at least one electromechanical equipment.

Other one aspect of the present invention is to provide a non-transitory computer readable storage medium that is configured to execute a performance management method. The performance management method includes: receiving a plurality of targets and factors from an interface module; establishing a value-driven model based on the targets and the factors; setting a goal value for each of the targets by the input module; and monitoring the operation performance of at least one smart building based on the value-driven model and the goal value of each of the targets.

In summary, the present invention has significant advantages and performance compared with the prior art. The present invention has significant technology progress and high value in this industry. The present invention provides a value-driven module for multi-targets and predicts building performance so as to adjust electromechanical equipments of the building in a much more efficient way.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a performance management system according to one embodiment of the present invention;

FIG. 2 is a block diagram of a value-driven module according to one embodiment of this invention;

FIG. 3 is a flow chart illustrating a performance management method according to one embodiment of this invention; and

FIG. 4 is a block diagram of an input interface according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

Although the terms “first,” “second,” etc., may be used herein to describe various elements, these elements should not be limited by these terms. These terms are used to distinguish one element from another.

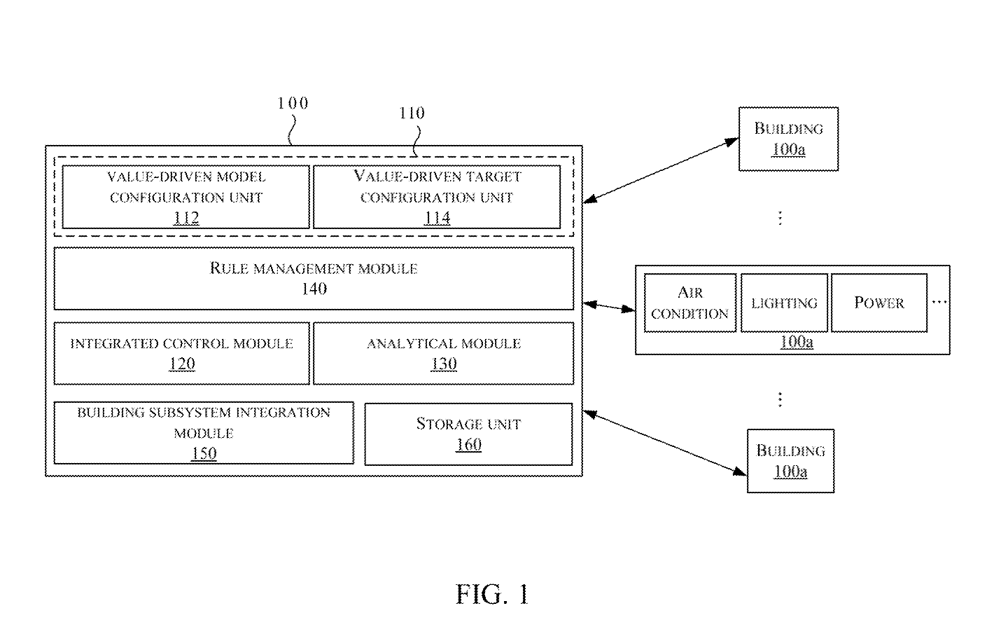

Referring to FIG. 1, FIG. 1 illustrates a block diagram of a performance management system according to one embodiment of the present invention. As shown in FIG. 1, the performance management system 100 monitors and manages a plurality of buildings 100a, and the performance management system 100 includes a value-driven management module 110 and an integrated control module 120.

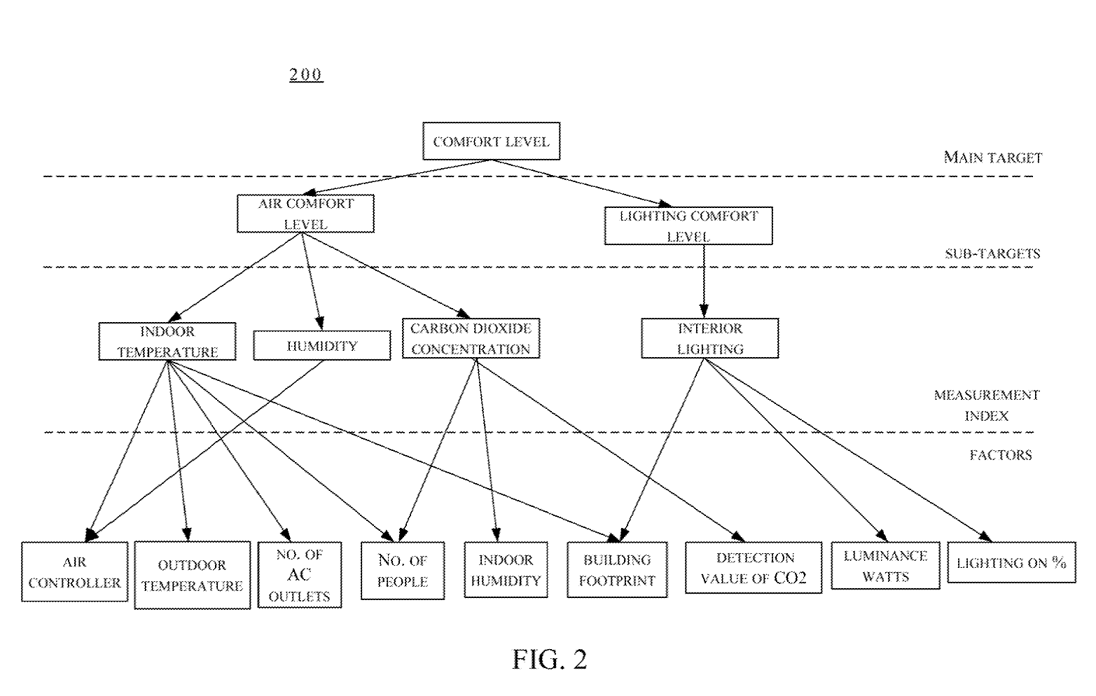

The value-driven management module 110 includes a value-driven model configuration unit 112 and a value-driven target configuration unit 114. The value-driven model configuration unit 112 is configured to configure a value-driven model (as shown later in FIG. 2). The value-driven model includes a plurality of targets (for instance, costs, comfort level, efficiency, carbon emissions, etc), and each target responds to a plurality of factors (for instance, comfort level responds to air comfort level, lighting comfort level, temperature, etc.). The value-driven target configuration unit 114 is configured to set a goal value for each of the targets (for example, expected indoor temperature, expected operation costs, etc.). The integrated control module 120 is configured to monitor electromechanical equipments of the buildings 100a in accordance with the value-driven model and the goal values of each of the targets. In various embodiments of the present invention, the buildings 100a are smart buildings, and the electromechanical equipments of the building 100a includes a Heating, Ventilation and Air Conditioning (HVAC), lighting system or power system, etc.

Furthermore, the aforementioned performance management system 100 can be applied to maintenance and management for multi-communities. The following paragraphs will discuss some embodiments about functions and applications of the performance management system 100. For illustration, the following embodiments only illustrate and describe management for a single building, but the present invention is not limited to these embodiments.

FIG. 2 illustrates a block diagram of a value-driven model according to one embodiment of this invention. As shown in FIG. 2, the value-driven management module 110 utilizes a tree chart to establish a value-driven model 200. However, the present invention is not limited thereof. The value-driven model 200 can be established with the hierarchical flow analysis diagrams, which include a tree chart, a fishbone diagram or a mind map, etc.

For illustration, the following description will be directed to single target (comfort level) of the value-driven model 200. General speaking, the comfort level is related to an air comfort level and a lighting comfort level. Thus, system administrator uses the value-driven management module 110 to configure the air comfort level and the lighting comfort level as sub-targets of the comfort level.

Moreover, the air comfort level is related to a plurality of measurement index, such as indoor temperature, humidity, carbon dioxide concentration, etc. The lighting comfort level is related to the measurement index such as indoor lighting, etc. In addition, each of the measurement indexes is related to a plurality of factors. Take “indoor temperature” as an example, the factors related to the indoor temperature include air controller, outdoor temperature, number of air conditioner outlets, number of people, building footprint, etc.

According to the descriptions above, the system administrator can establish the value-driven model 200 by setting the factors related to multiple targets step by step. Take costs and comfort level as an example, the sub-targets related to both of the costs and the comfort level are electricity fee and the temperature. The electricity fee and the temperature correspond to the factors related to air conditioner. The electricity fee increases, when the air conditioner temperature is configured to be lower. That is, there is a trade-off between the electricity fee and the temperature. The system administrator can utilize the value-driven model configuration unit 112 to configure relationships of the factors.

Similarly, the value-driven management module 110 establishes a value-driven model having multiple targets (for instance, operation costs, comfort level, safety, etc.). There is a hierarchical relationship between each of the targets and related factors.

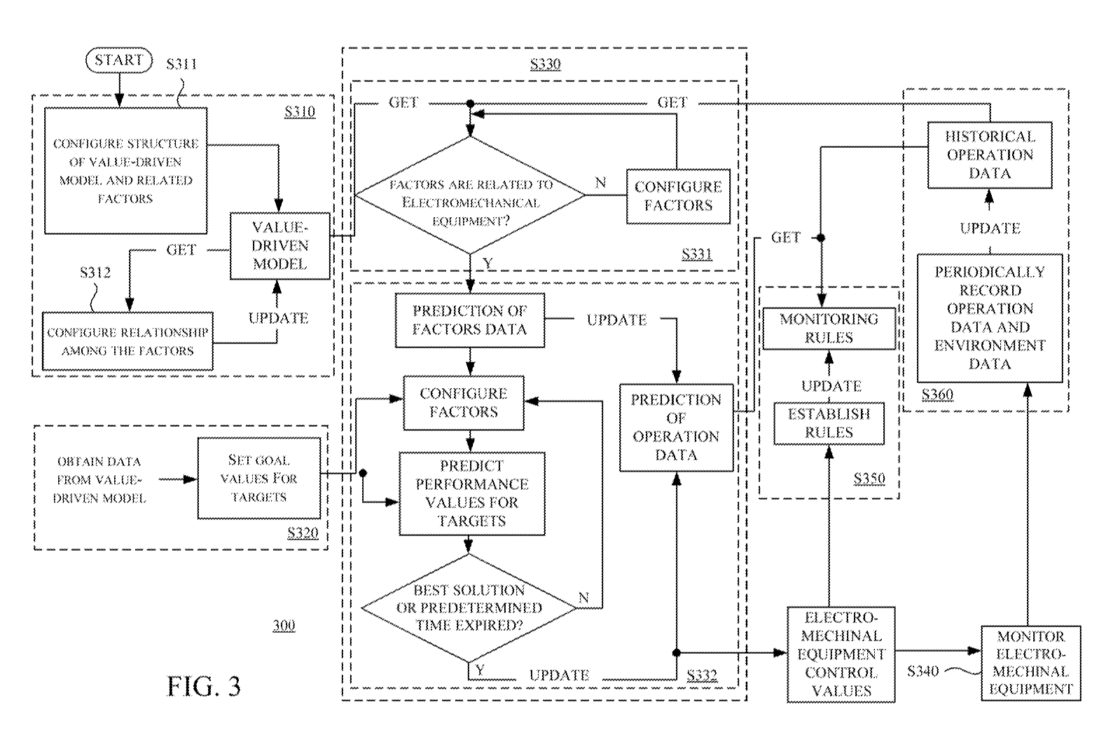

FIG. 3 illustrates a flow chart illustrating a performance management method according to one embodiment of this invention. A performance management method 300 may be a computer program product (e.g., application program) and may be stored at a non-transitory computer readable storage medium so that computer can read the non-transitory computer readable storage medium and execute the performance management method 300. The non-transitory computer readable storage medium includes a read-only memory, flash memory, floppy drive, hard drive, optical disk, thumb disk, magnetic tape, cloud database or equivalents

Please refer to FIGS. 1-3. For illustration purpose, the performance management system 100 of FIG. 1 and the performance management method 300 will be explained altogether.

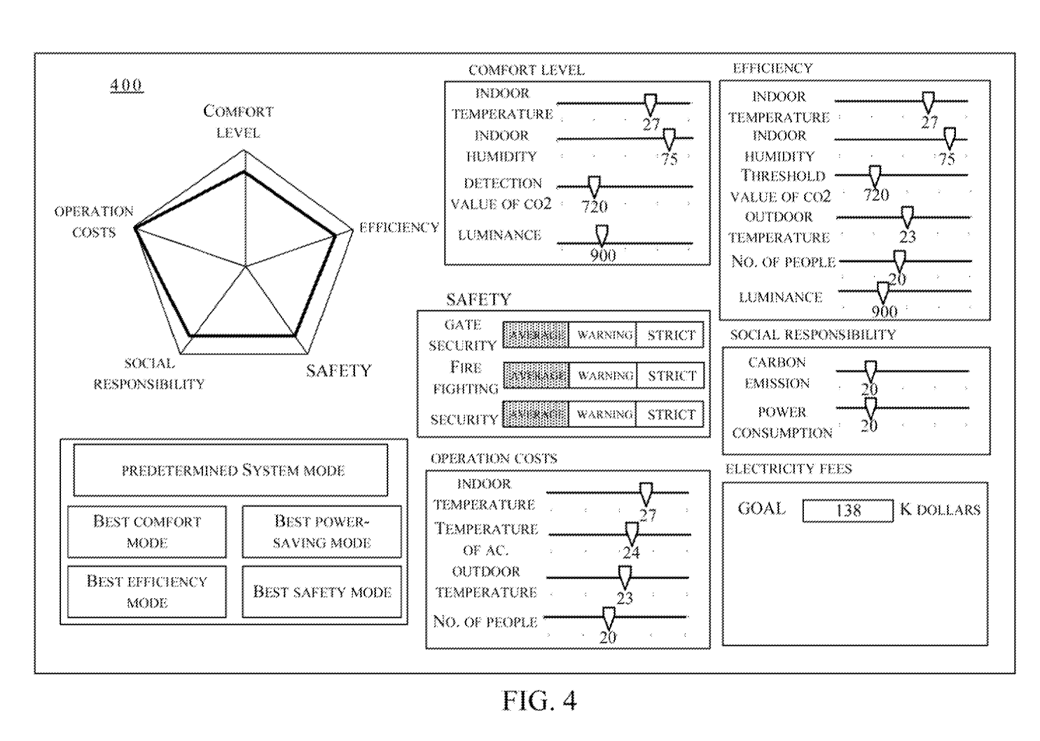

At step S310: the value-driven model configuration unit 112 (as shown in FIG. 4) configures a value-driven model (e.g., the value-driven model 200 as shown in FIG. 2) with a plurality of targets by an input interface (as shown in FIG. 4). The input interface includes keyboard, mouse or touch input device.

Specifically, as shown in FIG. 3, at step S310, the value-driven model configuration unit 112 configures structure of the value-driven model (e. g. tree chart) and related factors, so as to setup the value-driven model (step S311). Subsequently, the value-driven model configuration unit 112 configures relationship between the factors, so as to update the value-driven model (step S312).

At step S320: The value-driven target configuration unit 114 sets the goal values for the targets for the value-driven model by using the input interface. For instance, the system administrator uses the value-driven target configuration unit 114 to configure targets of operation costs and comfort level in the current month.

As shown in FIG. 1, in another one embodiment of the present invention, the performance management system 100 further includes an analytical module 130. The analytical module 130 is configured to analyze operation data of the electromechanical equipments and the environment data of the building 100a, so as to obtain items of the factors corresponding to the building 100a, and the analytical module 130 configures the value-driven model according to the items of the factors corresponding to the building 100a. (step S330). The operation data of electromechanical equipment includes power consumption, historical data and configurations of the electromechanical equipment, and the environment data includes outdoor temperatures and humidity of building 100a, indoor temperatures and humidity of building 100a, brightness, weather information, etc.

For example, at step S310, the target of the comfort level of the value-driven model is related to the factors, such as indoor temperature, and carbon dioxide concentration, etc, and the indoor temperature and the carbon dioxide concentration are related to some factors, such as air condition configuration, outdoor temperature and outdoor humidity. However, the factors that are capable of being controlled by the electromechanical equipment of the building 100a include air conditioner configuration (such factors called as “controllable factor” hereinafter), whereas the outdoor temperature and outdoor humidity cannot be controlled by electromechanical equipment of the building 100a (such factors called as “uncontrollable factors” hereinafter). Thus, at step S331, the analytical module 130 compares operation data from electromechanical equipment of the building 100a with the value-driven model, which has been previously configured, to obtain a plurality of the controllable factors and the controllable factors of the value-driven model, corresponding to relate to the electromechanical equipment of the building 100a. The analytical module 130 further configures relationships between controllable factors and uncontrollable factors of the value-driven model.

Furthermore, in one embodiment of the present invention, the analytical module 130 generates a prediction of operation data in accordance with operation data, environment data and the items corresponding to the factors (i.e., the controllable factors). (Step S332)

In detail, at step S332, the analytical module 130 generates a prediction of factor data of the factors (i.e., both of the controllable factors and the uncontrollable factors) based on the historical operation data of electromechanical equipment of the building 100a and environment data (for instance, weather, temperature, etc.) of the building 100a. For instance, the analytical module 130 predicts air conditioner configuration and local weather forecast (humidity and outdoor/indoor temperature) of the month of this year based on temperature configuration and local weather forecast (humidity and outdoor/indoor temperature) of the same month of previous year.

Furthermore, at step S332, the analytical module 130 further configures the items (i.e., the aforementioned controllable factors) corresponding to the factors in accordance with the goal values for the targets and the prediction of the factor data, so as to generate a prediction of performance values for the targets.

For example, after generating a prediction of weather data of the month of this year, related parameters of the air conditioning system are further configured based on the goal values for the costs and the comfort level, so as to calculate a prediction of performance values for the targets after making trade-offs among the targets, such as a prediction of costs, power consumption, carbon emissions, etc.

According to various embodiments of the present invention, the analytical module 130 further configures a predetermined operation time. During the predetermined operation time, the analytical module 130 may calculate the best solution based on the predictions of performance values, which are obtained by performing the aforementioned operations a number of times. While the predetermined operation time expires, the analytical module 130 may choose the best solution achieved during the operation, based on the predictions of performance values.

At the step S332, the analytical module 130 generates a prediction of operation data and electromechanical equipment control values based on the best prediction of performance values and the corresponding configured factors. The prediction of operation data includes the prediction of factor data corresponding to the best prediction of performance values and the setup value of the configured factors. At the step S340, the integrated control module 120 controls the electromechanical equipment of the building 100a based on the electromechanical equipment control value. Thus, the performance management method 300 of the embodiment can efficiently measure the targets and predict the targets so as to monitor the performance of the building 100a.

Further referring to FIG. 1, according to one embodiment of the present invention, the performance management system 100 further includes a rule management module 140. The rule management module is configured to establish a plurality of monitoring rules based on the electromechanical equipment control value, and to control the electromechanical equipment in accordance with the operation data, the prediction of operation data and the monitoring rules (step S350).

For example, at the step S320, while the goal value for the carbon dioxide concentration is set to 800 ppm for the air conditioning system to ventilate a room in order to maintain a certain comfort level. After the analytical module 130 configures the value-driven model, the goal value for the carbon dioxide concentration is changed to 700 ppm such that the air conditioning system can be turned on earlier to meet the goal value for the comfort level. Thus, at the step S350, the rule management module 140 setups and updates the monitoring rules in real-time based on the operation data and the electromechanical equipment control value, so as to automatically adjust the electromechanical equipment, and the rule management module 140 informs the system administrators whether the electromechanical equipment is abnormal.

As shown in FIG. 1, according to the various embodiments, the performance management system 100 further includes a building subsystem module 150. The building subsystem module 150 is configured to periodically record the operation data of the electromechanical equipment and environment data of the building 100a so as to provide these data with the analytical module 130 for analysis (step S360). Specifically, at the step S360, the building subsystem module 150 uses temperature, voltage, and air detectors to periodically record the environment data (indoor/outdoor temperature or humidity) and the operation data and configuration of the electromechanical equipment of the building 100a.

In addition, as shown in FIG. 1, the performance management system 100 further includes a storage unit 160. The storage unit 160 is configured to store the aforementioned data such as operation data, environment data, prediction of factor data, prediction of operation data, the mechanical equipment control values, etc. The storage unit 160 includes a read-only memory, flash memory, floppy drive, hard drive, optical disk, thumb disk, magnetic tape, cloud database or equivalents.

Referring to FIG. 4, FIG. 4 illustrates a block diagram of an input interface according to one embodiment of this invention. As shown in FIG. 4, an input interface 400 is configured to configure the targets, which include comfort condition, operation costs, efficiency, social responsibility and safety strategy. The relationships among these targets are illustrated by a radar chart. The comfort level is related to the factors: indoor temperature, indoor humidity, carbon dioxide concentration and luminance. The operation costs are related to the factors: indoor temperature, air condition set temperature, outdoors temperature and number of people indoor. The safety strategy is related to the factors, which include gate security, fire fighting, and security. The social responsibility is related to carbon emission. Thus, after the performance management system 100 configures a value-driven model with the targets, the system administrators can use the input interface 400 to configure the targets or control the targets by predetermined control mode, so as to monitor the building 100a in efficient way.

As mentioned above, the performance management system 100 or the performance management method 300 may be implemented in terms of software, hardware and/or firmware. For instance, if the execution speed and accuracy have priority, then the performance management system 100 may be implemented in terms of hardware and/or firmware. If the design flexibility has higher priority, then the performance management system 100 may be implemented in terms of software. Furthermore, the performance management system 100 may be implemented in terms of software, hardware and firmware in the same time. It is noted that the foregoing examples or alternates should be treated equally, and the present invention is not limited to these examples or alternates. Anyone who is skilled in the prior art can make modification to these examples or alternates in flexible way if necessary.

In summary, the performance management system of the present invention uses the value-driven model with targets and predicts performance of building so as to efficiently adjust the electromechanical equipment of the building.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A performance management system, comprising:
a value-driven management module, comprising:
a value-driven model configuration unit configured to configure a value-driven model with a plurality of targets, and the targets responding to a plurality of factors; and
a value-driven target configuration unit configured to set a goal value for each of the targets; and
an integrated control module configured to monitor operation performance of at least one building in accordance with the goal value for each of the targets and the value-driven model.

2. The performance management system of claim 1, further comprising:
an analytical module configured to obtain the items corresponding to the factors in accordance with operation data of at least one electromechanical equipment of the at least one building and at least one environment data of the at least one building, and configure the value-driven model in accordance with the items corresponding to the factors, wherein the items corresponding to factors are related to the at least one electromechanical equipment.

3. The performance management system of claim 2, wherein the analytical module generates a prediction of operation data in accordance with the operation data, the environment data and the items corresponding to the factors.

4. The performance management system of claim 3, wherein the analytical module generates a prediction of factor data in accordance with the operation data, the environment data and the factors, and wherein the analytical module configures the items corresponding to the factors in accordance with the goal value for each of the targets and the prediction data, so as to generate a prediction of performance values for the targets.

5. The performance management system of claim 4, wherein the analytical module generates a prediction of operation data in accordance with the prediction of performance values and the configured items corresponding to the factors;
wherein the analytical module further generates an electromechanical equipment control value in accordance with the prediction of factor data and the prediction of operation data, and the integrated control module controls the at least one electromechanical equipment in accordance with the electromechanical equipment control value.

6. The performance management system of claim 5, further comprising:
a rule management module configured to establish at least one monitoring rule in accordance with the electromechanical equipment control value, wherein the rule management module monitors the at least one electromechanical equipment in accordance with the operation data, the prediction of operation data and the at least one monitoring rule.

7. The performance management system of claim 2, further comprising:
a building subsystem integration module configured to periodically record the operation data and the environment data;
wherein the analytical module is further configured to obtain the operation data and the environment data from the building subsystem integration module.

8. A performance management method for managing at least one smart building with at least one electromechanical equipment, the performance management method comprising:
configuring a value-driven module, wherein the value-driven module comprises a plurality of targets responding to a plurality of factors;
configuring a goal value for each of the targets; and
monitoring the at least one electromechanical equipment in accordance with the value-driven module and the goal value for each of the targets.

9. The performance management method of claim 8, further comprising:
obtaining a plurality of items corresponding to a plurality of factors in accordance with an operation data of the at least one electromechanical equipment and an environment data of the smart building, and the items corresponding to the factors relate to at least one electromechanical equipment, so as to adjust the value-driven model; and
generating a prediction of factor data and a prediction of operation data in accordance with the operation data, the environment data and the items corresponding to the factors.

10. The performance management method of claim 9, wherein the step of generating a prediction of factor data and a prediction of operation data comprises:
configuring the items corresponding to the factors in accordance with the goal value for each of the targets and the prediction of factor data, so as to generate a prediction of performance values for the targets; and
generating the prediction of operation data in accordance with the prediction of performance values and the configured items corresponding to the factors.

11. The performance management method of claim 10, wherein the step of monitoring the at least one electromechanical equipment comprises:
generating an electromechanical equipment control value in accordance with the prediction of factor data and the prediction of operation data to monitor the at least one electromechanical equipment.

12. The performance management method of claim 9, further comprising:
establishing at least one monitoring rule in accordance with the electromechanical equipment control value; and
monitoring the at least one electromechanical equipment in accordance with the operation data, the prediction of operation data, and the at least one monitoring rule.

13. The performance management method of claim 9, further comprising:
periodically recording the operation data of the at least one equipment and environment data.

14. A non-transitory computer readable storage medium for executing a performance management method, the performance management method comprising:
receiving a plurality of targets and factors from an input interface;
establishing a value-driven model in accordance with the targets and the factors;
configuring a goal value for each of targets by the input interface; and
monitoring the operation performance of at least one smart building in accordance with the value-driven model and the goal value for each of the targets.

15. The non-transitory computer readable storage medium of claim 14, wherein the performance management method further comprises:
obtaining a plurality of items corresponding to the factors in accordance with an operation data of at least one electromechanical equipment and an environment data of smart building, so as to configure the value-driven model, wherein the items corresponding to the factors are related to the at least one electromechanical and equipment; and
generating a prediction of factor data and a prediction of operation data in accordance with the operation data, the environment data and the items corresponding to the factors.

16. The non-transitory computer readable storage medium of claim 15, wherein the step of generating a prediction of factor data and a prediction of operation data comprises:
configuring the items corresponding to the factors in accordance with the goal value for each of the targets and the prediction of factor data, so as to generate a prediction of performance values for the targets; and
generating the prediction of operation data in accordance with the prediction of performance values and the configured items corresponding to the factors.

17. The non-transitory computer readable storage medium of claim 16, wherein the step of monitoring the at least one electromechanical equipment comprises:
generating an electromechanical equipment control value in accordance with the prediction of factor data and the prediction of operation data to monitor the at least one electromechanical equipment.

18. The non-transitory computer readable storage medium of claim 14, wherein the performance management method further comprises:
establishing at least one monitoring rule in accordance with the electromechanical equipment control value; and
monitoring the electromechanical equipment in accordance with the operation data, the prediction of operation data, and the at least one monitoring rule.

19. The non-transitory computer readable storage medium of claim 14, wherein the performance management method further comprises:
periodically recording the operation data and the environment data of the at least one electromechanical equipment.
